(19) United States
(12) Patent Application Publication
(10) Pub. No.: US 2015/0041394 A1
(43) Pub. Date: Feb. 12, 2015

(54) Use of Carbon Nanotubes and Synthetic Mineral Clay for the Purification of Contaminated Waters

(71) Applicant: Universite Technologie de Compiegne - UTC, Compiegne cedex (FR)

(72) Inventors: Maksym Loginov, Kiev (UA); Mykola Lebovka, Kiev (UA); Eugene Vorobiev, Compiegne (FR)

(21) Appl. No.: 14/381,609

(22) PCT Filed: Feb. 28, 2013
(86) PCT No.: PCT/EP2013/054069

§ 371 Date: Aug. 28, 2014

(30) Foreign Application Priority Data
Feb. 29, 2012 (FR) 1251874

(51) Int. Cl. C02F 1/28; C02F 1/44

(52) U.S. Cl. CPC C02F 1/288; C02F 1/285; C02F 1/283; C02F 1/444; C02F 2101/20
USPC 210/638; 210/660; 210/691; 210/670; 210/679

(57) ABSTRACT

The present invention relates to a process for purifying water using a hybrid material based on carbon nanotubes and nanoparticles of clay, preferably laponite.

The present invention concerns a process for purifying water using a hybrid material containing carbon nanotubes and nanoparticles of clay, preferably Laponite.

Some purification methods of liquids containing various contaminants (ions, molecules, nanoparticles, viruses and bacteria) are based on the filtering of the contaminated liquids through ultra- or nano-filtration membranes. Ultrafiltration and nanofiltration however are very slow processes. This is why the application of these methods for purifying liquids is largely limited.

Chemical or physical treatment (e.g. the use of ozone, disinfection using UV radiation) can also be used for liquid purification. However these methods are not efficient for the removal of numerous toxic compounds such as organic or inorganic compounds for example.

It is generally recognised that the most efficient, fastest and simplest methods for purifying liquids are based on the use of adsorbent materials which selectively retain contaminants by contact with the contaminated liquid, followed by a step of separating the solids from the purified liquid by filtration, settling or centrifuging for example.

The efficacy of these purification methods is therefore determined by the physical and chemical properties of the sorbent used for purification. A good sorbent must meet the following criteria: have high external specific surface area, have high affinity for the contaminants, and the separation of the sorbent used from the purified liquid must be simple.

However most sorbents conventionally used for the purification of liquids e.g. natural and activated clays (see in particular US 2007/0031512), zeolites, activated charcoal, ion exchange resins, sand, have relatively limited applications for different reasons:

clays and zeolites are porous, their surface is therefore hardly accessible for large contaminant species, and purification of liquids is limited by diffusion of contaminants in the pores;

activated charcoal has low affinity for some contaminants (toxic ions of copper, iron, . . . );

activated clays and ion exchange resins have a small specific surface area, etc.

Synthetic materials are also used for purification of liquids and in particular materials formed of carbon nanotubes which have a relatively high specific surface area and good adsorption properties.

The adsorption and purification capacity of carbon nanotubes can be substantially improved by modifying the carbon nanotubes, in particular by modifying their surface by coating with other materials. In general this concerns treatment with precursors of metal oxides such as disclosed for example in Gong et al, Journal of Hazardous Materials, 2009, 164; 1517-1522. Composite materials of carbon nanotubes and alumina have also been described (see Amais et al., Separation and Purification Technology, 2007, 58, 122-128). Mention can also be made of the material NanoMesh® (see EP 1 852 176) formed of carbon nanotubes covalently bonded to a support material of polymeric or ceramic type. In addition, Zhao et al. (Applied Clay Science, 2011, 53, 1-7) synthesised hybrid composite materials formed of carbon nanotubes (CNTs) covalently bonded to exfoliated vermiculite, a natural clay mineral having a specific surface area of 2.2 m²/g, by means of a process comprising a treatment step of the exfoliated vermiculite using iron and molybdenum salts, then a nanotube growth step on the functionalised vermiculite particles.

Such treatments cause the formation of different hybrid nanoparticles whose properties are determined by the chemical properties of the coating layer, whilst particle size is determined by the size of the carbon nanotube particles used.

The said hybrid materials can be used as sorbents for the treatment of water contaminated by toxic ions or viruses. However, the synthesis of these materials involves treatment steps at high temperature and/or chemical syntheses in several steps, and/or treatment with acids under highly corrosive conditions (e.g. heating the carbon nanotubes in nitric acid).

Therefore the total efficacy of purification methods based on the use of said hybrid sorbents containing carbon nanotubes appears to be low on account of the fairly high costs of the materials and the difficult implementation of processes to synthesise these covalently modified carbon nanotubes.

There is therefore a need for novel purification methods based on the use of synthetic sorbents which, compared with conventionally used sorbents, must have:

a large specific surface area;

strong affinity for various contaminants;

good porosity;

low cost price.

Surprisingly the Applicant has discovered a novel method for purifying contaminated liquids, based on the use of a new type of hybrid material composed of synthetic clay, preferably of Laponite type, and of multiwalled carbon nanotubes (MWCNTs).

In the present invention by <<hybrid material>> or <<composite material>> is meant a material composed of two or more constituents on nanometric scale and having a structure differing from the structures of its constituents taken separately. The constituents of said material are not covalently bonded. Preferably the said material is obtained by mere sonication of an aqueous suspension of said two or more constituents.

In the present invention by <<multiwalled carbon nanotube (MWCNT)>> is meant a carbon nanotube formed of several sheets of graphene, typically wound around each other.

In the present invention by <<clay>> is meant a silicate-containing mineral material. Clays notably include kaolins (e.g. kaolinite, dickite, halloysite, nacrite), smectites (e.g. montmorillonite, nontronite and saponite), illites, chlorites, perlite and vermiculite. The clay of the invention advantageously has a specific surface area of 20 m²/g or higher and more advantageously 200 m²/g or higher.

Preferably the said clay is a synthetic mineral clay, Laponite in particular. Laponite is synthetic smectite type clay, more specifically a synthetic magnesium phyllosilicate. Typically Laponite contains substantially no aluminate unlike vermiculite. Laponite is available in particular under the trade name Laponite RD® (distributed by Rockwood Additives Ltd.), of formula Na_{0.7}[(Si₈Mg_{5.5}Li_{0.4})O₂₀(OH)₄] (see Zebrowski et al. Colloids Surf. A213, 2003, 189).

Laponite particularly has the capability of almost unlimited swelling in a solvent, in water in particular. This means that the clay can separate into individualised nanometric particles having a thickness of about 1 nm and has near unlimited (higher than 4 nm) basal spacing (inter-layer distance)(see Martin et al., Osmotic compression and expansion of highly ordered clay dispersions, 2006, Langmuir 22 (9), pp 4065-4075). In addition, when in suspension in water, Laponite is in the form of individualised nanometric particles, unlike vermiculite in particular which forms aggregates. Also the ions exchanged in Laponite are of monovalent type (e.g. lithium, sodium and potassium), whilst in vermiculite they are of bivalent type (e.g. magnesium and calcium).

Within the context of the present invention, the mean particle size of clay is defined as the mean size of individual particles measured using the atomic force microscopy method (Balnois, E., Durand-Vidal, S., Levitz, P., Probing the morphology of Laponite clay colloids by atomic force microscopy, 2003, Langmuir 19 (17), pp. 6633-6637). In the present invention by <<specific surface area>> is meant a characteristic of the particles (aggregates) expressed as the ratio of the total surface area of the particles (aggregates) per unit mass of particles (aggregates). Specific surface area is preferably measured using the Brunauer-Emmett-Teller method known as BET (see J. Am. Chem. Soc., 1938, 60, 309) when the contaminant is gaseous, or using the methylene blue adsorption method (see for example Loginov et al., Journal of Colloid and Interface Science, 3765 (2012) 127-136, or Yukselen and Kaya, Engineering Geology, 2008, 102, 38-45) when the contaminant is liquid or solid.

In the present invention by <<sorbent>> is meant any material exhibiting adsorption or absorption capabilities.

Also indifferent use is made in this invention of the terms <<purification>> and <<treatment>> to define the action of removing impurities contained in a product, and in particular within the context of the invention the removal of impurities from water.

One aspect of the invention therefore concerns the use of a hybrid material formed of multiwalled carbon nanotubes (MWCNTs) and of synthetic clay mineral having lamellar-shaped nanoparticles with specific surface area of 20 m²/g or larger, for the purification of contaminated waters.

A further aspect of the invention concerns a process for purifying water.

The present invention also concerns the use of a hybrid material formed of multiwalled carbon nanotubes and synthetic clay mineral having lamellar-shaped nanoparticles with specific surface area of 20 m²/g or larger, preferably Laponite, for the purification of contaminated waters.

The contaminated waters may be for example wastewater, industrial waters, partly retreated waters, waters that are accidentally contaminated.

The contaminated waters advantageously comprise contaminants selected from the group of biological compounds e.g. viruses, yeasts and bacteria in particular the yeast S. Cerevisiae, organic or inorganic compounds e.g. dyes such as methylene blue, surfactants, heavy metal salts such as iron salts, and mixtures thereof. Mention can also be made of petroleum derivatives as organic contaminant.

In one particular embodiment, the contaminants are dyes.

In another particular embodiment of the invention the contaminant is a product of interest.

In this invention by <<product of interest>> is meant an organic or inorganic biological or chemical compound that is of interest i.e. it is advantageous to recover this product separately for reuse thereof. For example mention can be made of organic compounds in particular ions of precious metals (gold, silver etc.), steroids, fermenting agents.

Therefore the present invention also concerns the use of a hybrid material composed of multiwalled carbon nanotubes and synthetic clay mineral having lamellar-shaped nanoparticles with specific surface area of 20 m²/g or higher, preferably Laponite, for the extraction and/or separation of products of interest from a solution, for example a dilute solution.

The compound of interest is preferably a compound soluble in the aqueous solution, or the compound is in colloid form and in the form of an aqueous suspension.

The present invention also concerns a process for purifying water comprising the successive steps of:

a) Contacting the contaminated water to be purified with a sufficient amount of hybrid material composed of multiwalled carbon nanotubes and of synthetic clay mineral having lamellar-shaped nanoparticles with specific surface area of 20 m²/g or larger, preferably Laponite, for a time of between 30 seconds and 3 h, preferably between 1 minute and 3 h, more preferably between 1 and 30 minutes or between 30 seconds and 30 minutes, the time needed for purification of the said contaminated water, optionally under agitation;

b) Separating the hybrid material and purified water;

c) Recovering the purified water;

d) Optionally regenerating the hybrid material.

Water purification may also mean that the contaminants are adsorbed, deactivated and/or degraded.

The contaminated water comprises contaminants preferably selected from the group formed by biological compounds e.g. viruses and bacteria, organic or inorganic compounds e.g. dyes, surfactants, heavy metal salts, petroleum derivatives and mixtures thereof.

In one embodiment the contaminant is a dye.

In one particular embodiment, the hybrid material used in step a) is preferably added as a suspension or as a powder. The process implemented is therefore preferably a batch type process.

Advantageously the separation of step b) takes place by filtration and/or centrifugation and/or settling and/or magnetic separation and/or flotation. For a purifying process of continuous type, preference is given to a filtration technique, magnetic separation or flotation. For a batch type process, centrifugation or settling can be used.

In one embodiment of the invention the separation of step b) takes place by filtration using a membrane of mean pore size between 0.1 μm and 2.5 μm, preferably between 0.1 and 0.5 μm, more preferably of about 0.2 μm.

In one particular embodiment, the hybrid material is used in a mixture with particles selected from the group consisting of sand, diatomites, zeolites, activated charcoal, activated natural clays, silica, additives intended to facilitate separation of the hybrid particles from the purified water, and mixtures thereof.

By <<additive intended to facilitate separation>> in the present invention is meant an additive ensuring complete separation of the hybrid particles and contaminants from the purified liquid and/or an increase in separation rate. Particular mention can be made of flocculants and coagulants, of polymeric type in particular.

In one particular embodiment of the invention, the hybrid material is immobilised on a solid support, advantageously a porous solid support, more advantageously a support allowing facilitated implementing of the separation step, preferably by filtration. For example the porous solid support advantageously has a mean pore size of between 0.1 μm and 2.5 μm, preferably between 0.1 and 0.5 μm, more preferably it is about 0.2 μm. This embodiment is particularly suitable for a continuous process.

Regeneration step d) preferably comprises physical and/or chemical treatment of the hybrid material containing the contaminants. In particular chemical treatment of the hybrid material can be performed by contacting with an acid solution, a solution of sodium hydroxide, complexants, oxidants, enzymes, non-organic solvents or other products which allow the desorption and/or dissolution of the impurities on the surface of the hybrid material used. Persons skilled in the art can choose the most appropriate chemical regeneration treatment in relation to the type of contaminant absorbed or adsorbed on the hybrid material.

The use and processes of the invention have recourse to a hybrid material composed of multiwalled carbon nanotubes and of synthetic clay mineral having lamellar-shaped nanoparticles with specific surface area equal to or greater than 20 m²/g.

The synthetic clay mineral having lamellar-shaped nanoparticles and specific surface area equal to or greater than 20 m²/g, is preferably clay consisting essentially of magnesium silicate, or preferably synthetic magnesium phyllosilicate such as Laponite. Vermiculite in particular is excluded from the field of the invention since it does not allow a non-covalent hybrid material to be obtained having satisfactory sorbent properties.

By <<consisting essentially of>> in the present invention is meant that the material comprises at least 95% by weight of the element under consideration.

Advantageously, the synthetic mineral clay having lamellar-shaped nanoparticles with specific surface area equal to or greater than 20 m²/g has a mean particle size of between 1 and 100 nm, more advantageously of between 1 and 50 nm, even more advantageously of between 1 and 30 nm.

The synthetic mineral clay having lamellar-shaped nanoparticles with specific surface area equal to or greater than 20 m²/g is obtained for example using a method that is simple to implement and of most advantageous cost price (see M. Loginov, N. Lebovka, E. Vorobiev. Laponite assisted dispersion of carbon nanotubes in water. Journal of Colloid and Interface Science, 365 (2012) 127-136). The said hybrid material has high surface activity and large specific surface area.

In one particularly preferred embodiment the said clay is a synthetic magnesium phyllosilicate, water insoluble and in particular having large swelling capacity, such as Laponite. The hybrid material of the invention or used in the process of the invention is obtained by simple sonication of an aqueous suspension of multiwalled carbon nanotubes and Laponite, preferably at ambient temperature and neutral pH, following the method described by Loginov et al. (Journal of Colloid and Interface Science, 365 (2012) 127-136, incorporated herein by reference in its entirety). The said Laponite-MWCNT hybrid material when used in suspension in water forms substantially no aggregates or packets, even after storage of the suspension at a temperature between 0° C. and ambient temperature. The said Laponite-MWCNT hybrid material results from the separation and stabilisation of the nanotubes individualised by the Laponite particles.

By comparison Laponite alone—a synthetic clay of large specific surface area in particular larger than 200 m²/g—is not suitable for purifying liquids since its constituent particles are very small: the thickness and diameter of Laponite particles are about 1 nm and 30 nm, and an aqueous dispersion of Laponite has a mean particle size of between about 1 and 100 nm. As a result, the particles of Laponite alone which do not precipitate are difficult to filter and contaminate the solution to be purified.

In addition, although multiwalled carbon nanotubes alone are in general easy to separate from an aqueous solution by filtration, centrifugation or settling on account of their long length (about 1 μm), they do not have sufficient absorption capacity for satisfactory purification of contaminated water.

Therefore the use of the hybrid material according to the invention has unforeseen advantages compared with these two materials considered separately, namely better adsorption properties and a size allowing easy separation from the aqueous solution to be purified.

### FIGURES

FIG. 1: Schematic illustration of the process for purifying a contaminated liquid according to the invention, embodiment 1: mixing of the contaminated liquid (a) with an aliquot of Laponite-MWCNT hybrid material (b); then filtration or centrifuging of the suspension obtained (c), leading to the formation of a purified filtrate or supernatant (d).

FIG. 2: Schematic illustration of the process for purifying a contaminated liquid according to the invention, embodiment 2: Depositing the hybrid particles on a porous support (a); leading to the formation of a layer of immobilised hybrid particles (b); Filtering the contaminated liquid through the layer of Laponite-MWCNT hybrid material deposited on the porous support (c).

FIG. 3: Schematic illustration of the formation of a stable suspension of Laponite-MWCNT hybrid material by sonication, and the structure of hybrid particles thus obtained.

FIG. 4: Photographs of an initial unstable aqueous MWCNT suspension containing 0.01 weight % MWCNT (a) and of the MWCNT suspension stabilised with Laponite at a Laponite concentration X=0.5, obtained after sonication (X is the ratio between Laponite mass and MWCNT mass in the suspension) (b).

FIG. 5: Photographs of: (a) model solution with 5×10⁻⁶ methylene blue (MB); (b) hybrid Laponite-MWCNT suspension; (c) 5×10⁻⁶ g/ml methylene blue (MB) solution mixed with an aliquot of hybrid Laponite-MWCNT solution; (d) solution obtained after filtering the suspension (c) (filtrate).

FIG. 6: Relative absorbance (Y-axis) of purified methylene blue solution (d) obtained using the process in FIG. 5, as a function of volume of aliquot (b) of hybrid Laponite-MWCNT suspension used (X-axis). The initial volume and concentration of the methylene blue (MB) solution are 100 ml and 5×10⁻⁶ g/ml respectively. The hybrid suspension contains 0.01 weight % of MWCNT and a Laponite concentration of 0.5 (ratio between Laponite mass and MWCNT mass contained in the suspension).

FIG. 7: Quantity of methylene blue (MB) removed using the hybrid Laponite-MWCNT suspension expressed in g of MB/g of MWCNT(Y-axis) as a function of the initial concentration of methylene blue (MB) (expressed in g of MB/g of MWCNT) (X-axis). The Laponite concentration (ratio between Laponite mass and MWCNT mass in the suspension) contained in the hybrid solution is X=0.5

FIG. 8: Maximum absorption (expressed in g of MB per g of MWCNT) of a solution purified with a hybrid Laponite-MWCNT suspension (solution initially contaminated with 10⁻⁶ M methylene blue) as a function of the concentration (ratio between Laponite mass and MWCNT mass in the suspension) of Laponite X in the hybrid solution. The squares correspond to implementing of the process of the invention wherein step b) is a centrifuging step, whilst the diamonds correspond to implementing of the process of the invention wherein step b) is a filtering step.

FIG. 9: Relative absorbance (ratio between absorbance of the filtrate and absorbance of the contaminated solution before treatment) of the filtrate (purified solution d) obtained according to FIG. 1 or 2) as a function of contact time (in minutes) of the MB solution with the suspension of hybrid Laponite-MWCNT material.

FIG. 10: Dependency of filtrate volume on filtration time for hybrid suspensions with different concentrations of Laponite X=0−0.5 and constant concentration of nanotubes Cn=0.01 weight % (Initial volume of suspension is 100 ml, filtering pressure is Δp=1 bar, filter surface is S=2.5×10⁻³ m²).

FIG. 11: Turbidity of the filtrate as a function of the surface concentration of hybrid particles on porous support. The initial volume of non-purified yeast suspension is 100 ml, the turbidity of the initial non-filtered suspension is 0.9±0.1, filtration pressure Δp=2 bars, the filter surface S=2.5×10⁻³ m², the concentration of Laponite in the hybrid material (ratio between Laponite mass and MWCN mass in the suspension) X=0.5.

FIG. 12: Quantity of Fe(II) removed with the hybrid Laponite-MWCNT suspension as a function of added Fe(II) concentration (example for mass ratio between Laponite and MWCNT in the suspension X=0.5). The initial volume of Fe(II) solution is 200 ml, the concentration of non-purified solution is 5×10⁻⁶ g Fe/ml, the amount of hybrid Laponite-MWCNT suspension used corresponds to 0.01 g MWCNT.

FIG. 13: Degree of purification calculated for different sorbents. The initial volume of Fe(II) solution is 200 ml, the concentration of non-purified solution is 5×10⁻⁶ g Fe/ml, the amount of sorbent used is 0.01 g MWCNT.

### EXAMPLES

The following examples are given solely for illustration and in no way limit the invention.

In the following examples, the hybrid material formed of multiwalled carbon nanotubes (MWCNTs) and synthetic clay mineral having lamellar-shaped nanoparticles with specific surface area equal to or greater than 20 m²/g, Laponite herein, is obtained following the method described in the article by M. Loginov, N. Lebovka, E. Vorobiev. Laponite assisted dispersion of carbon nanotubes in water. Journal of Colloid and Interface Science, 365 (2012) 127-136. The properties of the hybrid material thus obtained are described in this same article. The synthesis and structure of the said hybrid Laponite-MWCNT material are described in FIG. 3.

In the remainder hereof the said material will simply be designated by the expression <<hybrid Laponite-MWCNT material>>, <<hybrid particles>> or <<hybrid Laponite-MWCNT suspension>>.

In the remainder hereof X represents the ratio between the weight of Laponite and the weight of MWCNT contained in the hybrid material suspension.

In addition, the absorption of a material is defined as its capacity to absorb a contaminant, expressed in g of absorbed contaminant per 1 gram of MWCNT used in a suspension of hybrid material. When applicable this value is dependent on value X defined above.

### Example 1

### Purification of Water Contaminated with an Organic Chemical Compound (Dye)

The solution to be purified herein called <<model methylene blue (MB) solution>> is a 5×10⁻⁶ g/ml solution of methylene blue (MB).

Purification Using a Suspension of the Hybrid Material of the Invention

The schematic of a purification test is given in FIG. 1. The results obtained are given in FIG. 5.

The model MB solution was mixed with a 30 mL aliquot of 0.01 weight % hybrid material suspension, the suspension obtained being left under agitation for a time varying from 30 sec to 3 hours. The hybrid particles were then separated either by filtration or by centrifugation and the filtrate (or supernatant) obtained was analysed.

Purification Using a Hybrid Material of the Invention Immobilised on a Porous Solid Support.

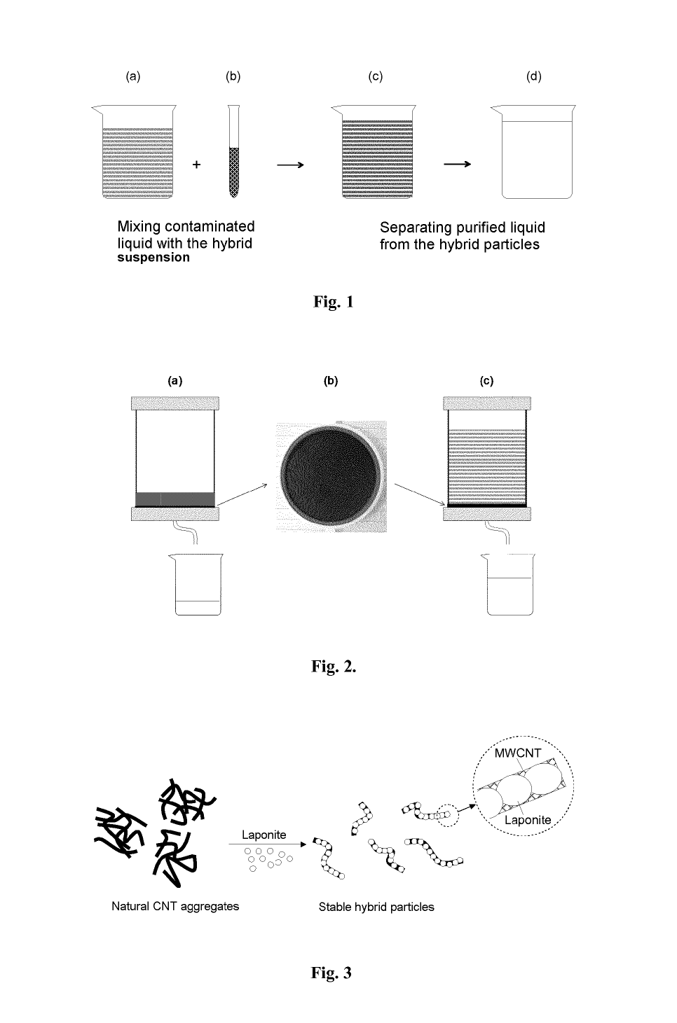

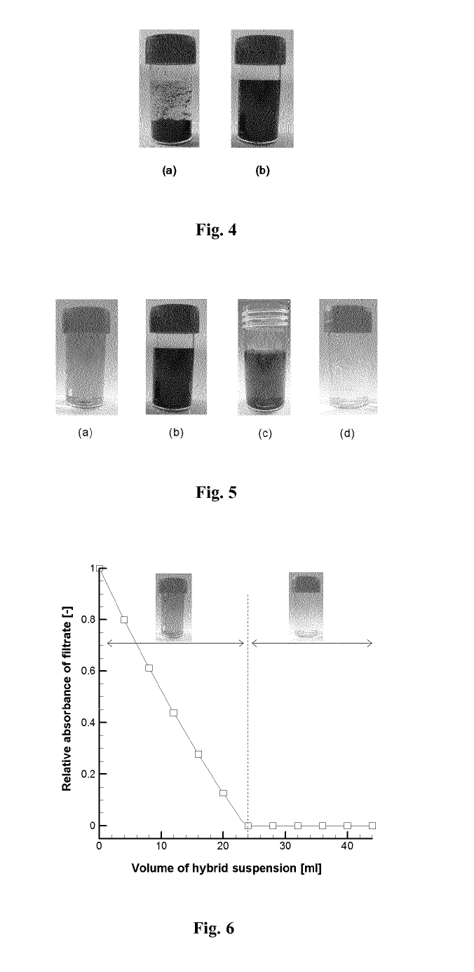

In parallel, another purification method was tested, schematically illustrated in FIG. 2. 100 mL of hybrid suspension were added and the hybrid Laponite/MWCNT material was left to deposit on a porous support (filtration membrane). In particular, a filtration membrane having a pore size of 0.2 μm fully retains the hybrid Laponite-MWCNT particles at any concentration of Laponite, the said concentration being denoted X.

A durable deposit (having the appearance of a thin black <<cake>>) was formed on the porous support (FIG. 2b).

The model solution of MB was then filtered through the deposited layer of hybrid particles, and a pure filtrate was obtained (FIG. 2c).

Results

In both cases, the purity of the final filtrate (supernatant) depended on the amount of hybrid particles used for purification. FIG. 6 shows the relative absorbance of filtrate as a function of the volume of hybrid suspension with a nanotube concentration of 0.01 weight % and X=0.5 used for purifying 100 ml of model MB solution.

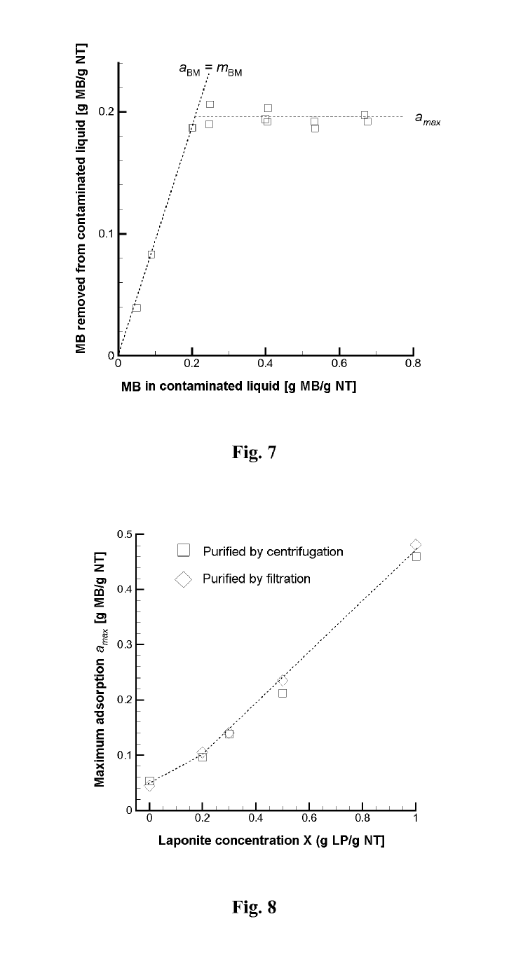

FIG. 7 gives the MB adsorption value as a function of the amount of MB added to the hybrid suspension.

It was found that the maximum adsorption of MB (or other impurity) on the surface of the hybrid particles is determined by the ratio CNT/Laponite in the hybrids. FIG. 8 gives the maximum MB adsorption as a function of the concentration of Laponite in the hybrids.

Therefore maximum adsorption (purifying capacity) of the hybrid CNT/Laponite material increases with the increase in Laponite concentration X. The value of maximum impurity adsorption does not depend on the purification method and method used to separate the hybrid particles from the purified solution (FIG. 8).

It was also found that at a Laponite concentration of X>0.2, the maximum adsorption of impurities is directly proportional to X (FIG. 8). It can therefore be concluded that when X>0.2 only the Laponite particles determine the surface and purifying properties of the hybrid suspension, whilst the nanotubes are merely <<carriers>> of the active Laponite particles. As a result, the purifying capacity of the hybrid particles can be considerably increased by increasing the Laponite concentration in the hybrid suspension.

However, in the absence of MWCNTs the Laponite particles cannot act as efficient sorbent. Tests have shown that, in the absence of nanotubes, the filtering of the Laponite suspension does not cause retention of the Laponite particles. Indeed without any MWCNTs the Laponite particles freely pass into and contaminate the filtrate, whilst the hybrid Laponite-MWCNT particles can be entirely retained by the support filter having a mean size of about 0.2 μm.

Also the adsorption and removal of contaminants using hybrid Laponite-MWCNT particles is relatively rapid. FIG. 9 shows the dependency of relative absorbance (staining) of a purified MB solution as a function of contact time of the initial MB solution with the hybrid suspension (after the contact time, the hybrid particles have been separated from the solution purified by filtration). It can be seen that the staining of the filtrate is reduced down to almost 0 even after a contact time of 30 seconds with the hybrid suspension. This implies very rapid purification of the MB solution.

It therefore appears that the hybrid particles are non-porous and their surface is easily assessable to the contaminants.

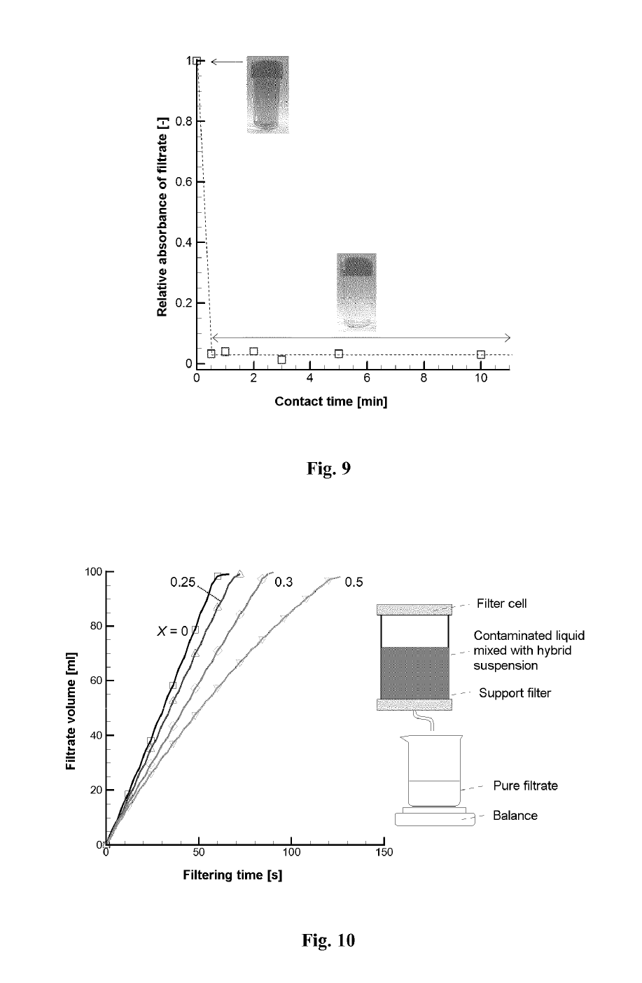

The separation of the hybrid particles used from the purified solution is also relatively rapid. FIG. 10 gives the filtration curves obtained when filtering the hybrid particles from the purified MB solutions. It can be seen that the filtering time needed for purification increases as and when X increases. The estimated value of the specific filtering resistance of the cake of hybrid particles (measurement of filterability) increases from 2×10¹² m/kg (when X=0) to about 10¹⁴ m/kg (when X=0.5), whereas the estimated value of specific filtration resistance for pure Laponite is much higher (about 10¹⁵ m/kg). Therefore the filterability of the suspension of hybrid material decreases with the increase in concentration of Laponite. However it remains fairly high compared with the filterability of the suspension of pure Laponite. The adding of MWCNTs to Laponite increases the filterability of the purifying material obtained.

### Example 2

### Purification of Water Contaminated with Biological Compounds

A suspension of hybrid particles of Laponite-MWCNT was used to purify liquids containing biological contaminants.

A stable model suspension was used obtained by settling a 1% stable model suspension of S. cerevisiae stabilised by ultrasound.

The model suspension obtained was highly turbid on account of the presence of fine biological contaminants (yeast cells and cellular debris). This suspension was subjected to the purification process of the invention as described in FIG. 2.

The hybrid suspension of Laponite-MWCNT was immobilised on a porous support having a nominal pore size of 2.5 μm. The surface concentration of the hybrid particles was varied from 0 to 1.6 MWCNT/m². The concentration X of Laponite (ratio between Laponite mass and MWCNT mass contained in the suspension of hybrid material) was 0.5.

The stable suspension of yeast was filtered through the layer obtained and the turbidity of the filtrate was measured. Turbidity is expressed as the relative absorbance of the filtrate (ratio between the absorbance of the filtrate and the absorbance of the contaminated solution before treatment) measured at 720 nm using 10 mm quartz optical cells.

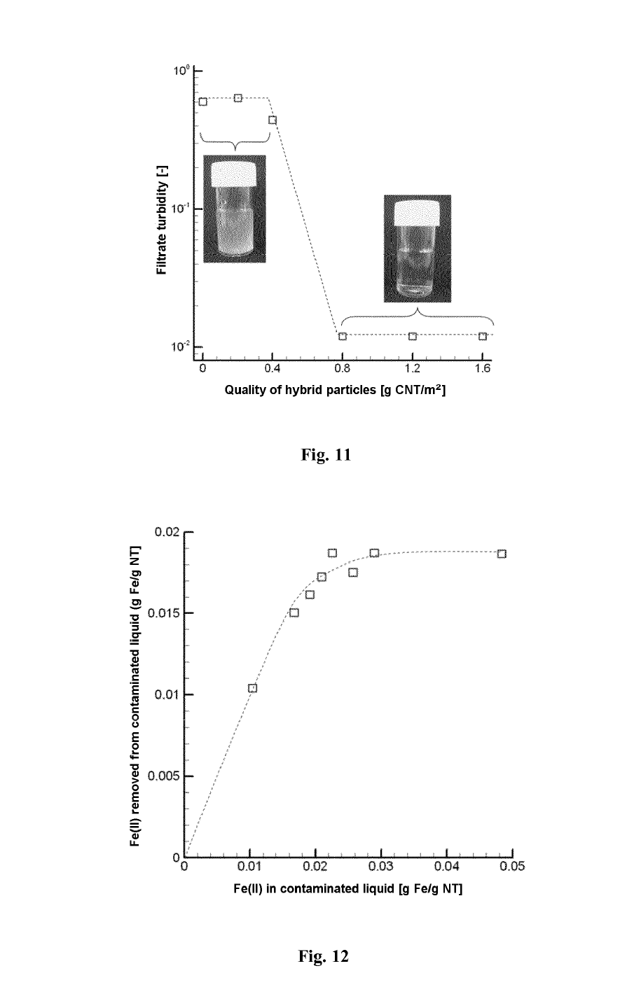

FIG. 11 shows the turbidity of the filtrate as a function of the surface concentration of the hybrid particles used to purify the stable yeast suspension.

In the absence of hybrid particles, the filtrate remains turbid and contaminated with yeast cells and cellular debris. However when the surface concentration of the hybrid particles increases, filtering causes complete retaining of the contaminants by the hybrid particles (at a hybrid particle concentration of 0.8 g MWCNT/m² or higher the turbidity of the filtrate is practically 0).

The process of the invention therefore allows efficient purification of liquids contaminated with biological contaminants, in particular colloidal contaminants.

### Example 3

### Purification of Water Contaminated with an Inorganic Chemical Compound (Heavy Metal Ion)

The process of the invention also allows the purification of liquids contaminated with heavy metals.

A model solution of FeSO4 having a Fe(II) concentration of 5×10⁻⁶ g/ml was used. This solution was subjected to the process of the invention in accordance with the method shown in FIG. 1.

Different quantities of hybrid suspension of Laponite-MWCNT (X=0.5) were used for purification. The concentration of Fe(II) in the initial solution and in the purified solutions was determined using a colorimetric method with 1,10-phenanthroline such as described in Belcher, R. “Application of chelate Compounds in Analytical Chemistry” Pure and Applied Chemistry, 1973, volume 34, pages 13-27.

FIG. 12 shows the value of Fe(II) adsorption as a function of the amount of added Fe(II). It can be seen that the Fe(II) is efficiently absorbed by the hybrid particles of Laponite-MWCNT.

The process of the invention therefore allows efficient purification of liquids contaminated by heavy metals.

### Example 4

### Comparative Examples

The purification process of the invention was compared with purification processes using conventional prior art sorbents (activated charcoal, zeolite and non-treated multiwalled carbon nanotubes).

For this comparison the same experimental conditions were followed as described above in Example 3.

Therefore 0.01 g of sorbent was mixed with 200 ml of solution having a Fe(II) concentration of 5×10⁻⁶ g/ml. The sorbents were then separated from the solutions to be purified by filtration and the iron content of the purified solutions was measured. The degree of purification was calculated as the ratio of the quantity of Fe(II) removed by the sorbent to the initial quantity of Fe(II) in the solution.

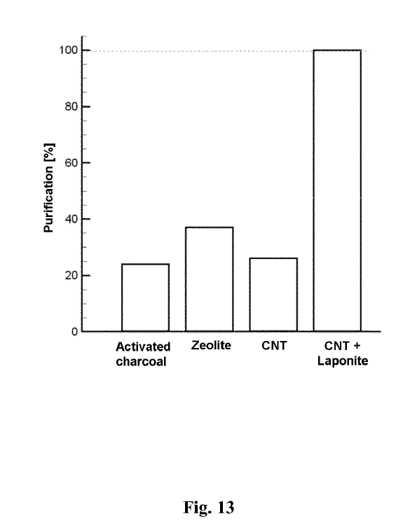

FIG. 13 gives the values of the degree of purification calculated for different sorbents.

FIG. 13 clearly shows that the process of the invention allows complete purification of the contaminated solution (the degree of purification is 100%), whilst the processes using other sorbents (activated charcoal, zeolite and non-treated multiwall carbon nanotubes) only allow partial purification of the solution (the degree of purification is less than 40%).

The process of the invention therefore allows a strong unforeseen improvement compared with prior art processes.

1. A method for the purification of contaminated waters, comprising using a hybrid material formed of multiwalled carbon nanotubes and of synthetic clay mineral having lamellar-shaped nanoparticles and specific surface area equal to or greater than 20 m²/g, for purifying contaminated waters, wherein the synthetic clay consists essentially of magnesium silicate.

2. (canceled)

3. The method of claim 1 wherein the synthetic clay mineral having lamellar-shaped nanoparticles and specific surface area equal to or greater than 20 m²/g is Laponite.

4. The method of claim 1, wherein synthetic clay mineral having lamellar-shaped nanoparticles and specific surface area equal to or greater than 20 m²/g has a mean particle size of between 1 and 100 nm.

5. The method of claim 1, wherein the contaminated waters comprise contaminants selected from the group of biological compounds, organic or inorganic compounds and mixtures thereof.

6. A method for extraction and/or separation of products of interest from a solution, comprising using a hybrid material formed of multiwalled carbon nanotubes and of synthetic clay mineral having lamellar-shaped nanoparticles and specific surface area equal to or greater than 20 m²/g, said clay consisting essentially of magnesium silicate, for extracting and/or separating products of interest from a solution.

7. A process for purifying water comprising the successive steps of:
a) contacting the contaminated water to be purified with a sufficient quantity of hybrid material formed of multiwalled carbon nanotubes and of synthetic clay mineral having lamellar-shaped nanoparticles and specific surface area equal to or greater than 20 m²/g, said clay consisting essentially of magnesium silicate, for a time of between 1 minute and 3 h, preferably between 1 and 30 minutes, the time needed to purify the said contaminated water, optionally under agitation;
b) separating the hybrid material from the purified water;
c) recovering the purified water;
d) optionally regenerating the hybrid material.

8. The process of claim 7, wherein the clay mineral is Laponite.

9. The process of claim 7, wherein the contaminated waters comprise contaminants selected from the group of biological compounds, organic or inorganic compounds and mixtures thereof.

10. The process of claim 7, wherein the separation in step b) is carried out by filtration and/or centrifugation and/or settling and/or magnetic separation and/or flotation.

11. The process of claim 7, wherein the separation at step b) takes place by filtration with a membrane of mean pore size between 0.1 μm and 2.5 μm, preferably between 0.1 and 0.5 μm, more preferably of about 0.2 μm.

12. The process of claim 7, wherein the hybrid material used at step a) is added as a suspension or as a powder.

13. The process of claim 7, wherein the hybrid material is used in a mixture with particles selected from the group formed by sand, diatomite, zeolites, activated charcoal, activated natural clays, silica, additives intended to facilitate the separation of the hybrid particles from the purified water, and mixtures thereof.

14. The process of claim 7, wherein the hybrid material is immobilised on a solid support, advantageously a porous solid support, more advantageously a support allowing facilitated implementing of separation at step b), preferably by filtration.

15. The method of claim 6, wherein the clay mineral is Laponite.
